(19) United States
(12) Patent Application Publication
(10) Pub. No.: US 2007/0291443 A1
(43) Pub. Date: Dec. 20, 2007

(54) Keyboard with light and sound effects

(76) Inventor: Wen-Lung Cheng, Taipei Hsien (TW)

Correspondence Address: WEN-LUNG CHENG, 235 Chung-Ho, Box 8-24, Taipei, omitted

(21) Appl. No.: 11/454,054

(22) Filed: Jun. 16, 2006

(51) Int. Cl. G06F 1/16

(52) U.S. Cl. 361/680

(57) ABSTRACT

A keyboard with light and sound effects comprises an auto-uncover keyboard cover having a main cover plate, a main spindle set, a sub-cover plate, a sub-cover spindle set, a liquid crystal screen, a trumpet set, and a sound control button set; a keyboard including a keyboard body, an light emitting set, and a main control button. The cover and uncover operations of the keyboard cover are performed by the main spindle set and sub-cover spindle set to drive the main cover plate and sub-cover plate and the main control button severs to control the liquid crystal screen, trumpet set, and sound control button set; and the light emitting set is installed below the keyboard body. Or the cover and uncover operations of the keyboard cover are manually operated, and the main spindle set and the sub-cover spindle set serves to connect the main cover plate sub-cover plate and the keyboard.

### FIELD OF THE INVENTION

The present invention relates to keyboards, and in particular to a keyboard with light and sound effects wherein the opening and closing operation of the keyboard can be performed automatically or manually, and the elevation of the angle of a main cover plate is fine-adjustable.

### BACKGROUND OF THE INVENTION

In the prior art, referring to FIG. 1, the keyboard 1 has no cover so that the dust will accumulate thereon or liquid permeates in the keyboard. As a result the keyboard 1 will be destroyed so as to decrease the lifetime of the keyboard. In one improvement, a plastic cover is used to protect the keyboard, however this only provides finite protection to the keyboard, but it cannot provide a beautiful outlook to the keyboard.

### SUMMARY OF THE INVENTION

Accordingly, the primary object of the present invention is to provide a keyboard with light and sound effects which comprises an auto-uncover keyboard cover having a main cover plate, a main spindle set of the main cover plate, a sub-cover plate, a sub-cover spindle set, a liquid crystal screen, a trumpet set, and a sound control button set; a keyboard including a keyboard body, an light emitting set, and a main control button. The cover and uncover operations of the keyboard cover are performed by the main spindle set and the sub-cover spindle set to drive the main cover plate and sub-cover plate and the main control button severs to control the liquid crystal screen, trumpet set, and sound control button set; and the light emitting set is installed below the keyboard body. Or the cover and uncover operations of the keyboard cover are manual operated, and the main spindle set and the sub-cover spindle set serves to connect the main cover plate sub-cover plate and the keyboard.

The various objects and advantages of the present invention will be more readily understood from the following detailed description when read in conjunction with the appended drawing.

### BRIEF DESCRIPTION OF THE DRAWINGS

FIG. 1 is a perspective view of a prior art keyboard.

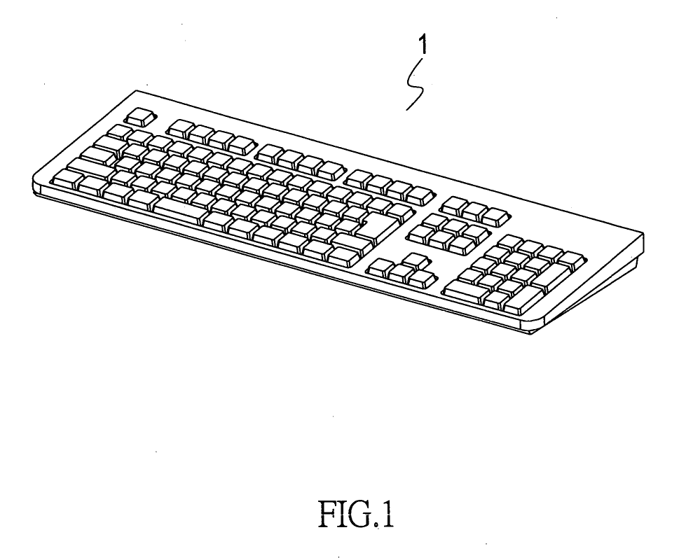

FIG. 2 is an expansion view of the present invention.

FIG. 3 is a perspective view showing that the keyboard is closed.

FIG. 4 is an expansion view of the present invention.

FIG. 5 is a lateral view of the present invention.

FIG. 6 is an enlarged cross sectional view of the sub-cover plate of the present invention.

FIG. 7 is a cross sectional view about the LED set and keys of the present invention.

FIG. 8 shows one application of the present invention.

### DETAILED DESCRIPTION OF THE INVENTION

In order that those skilled in the art can further understand the present invention, a description will be described in the following in details. However, these descriptions and the appended drawings are only used to cause those skilled in the art to understand the objects, features, and characteristics of the present invention, but not to be used to confine the scope and spirit of the present invention defined in the appended claims.

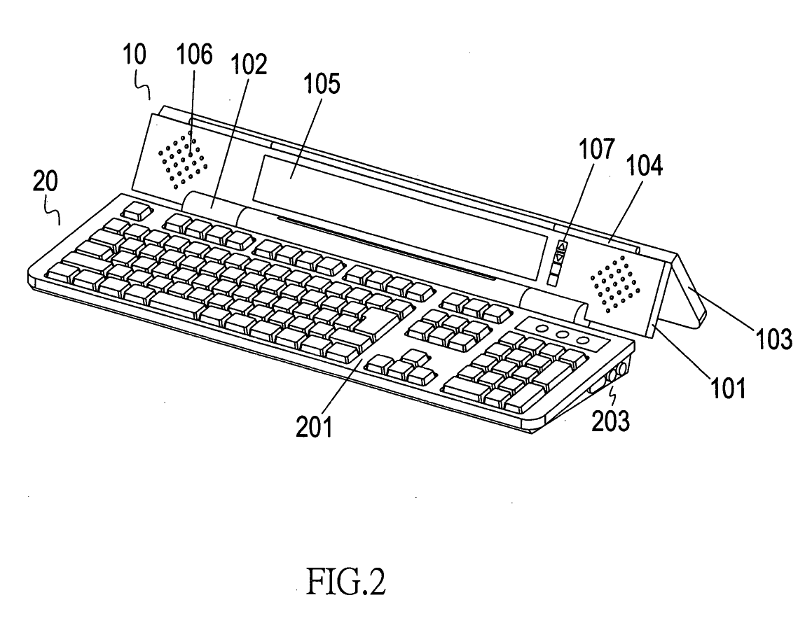

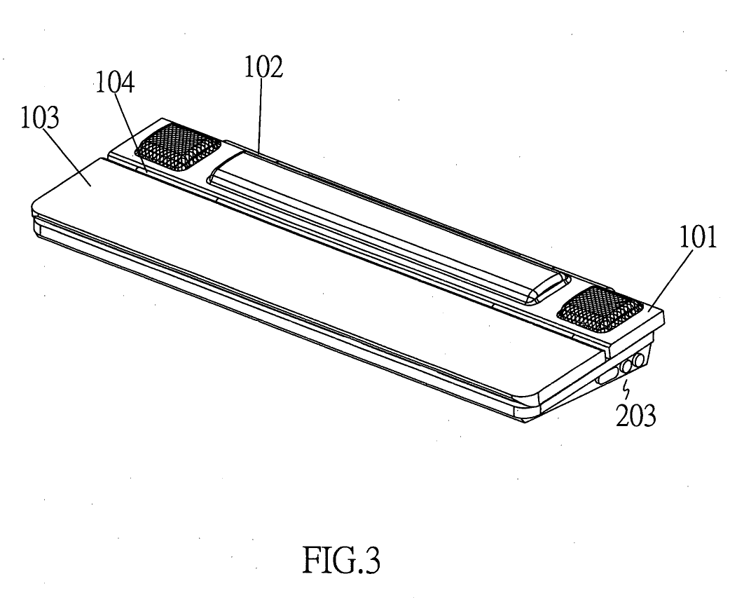

Referring to FIGS. 2, and 3, the structure of the present invention is illustrated. The present invention has the following elements.

A keyboard cover 10 has a main cover plate 101, a main spindle set 102 of the main cover plate 101, a sub-cover plate 103, a sub-cover spindle set 104, a liquid crystal screen 105, a trumpet set 106, and a sound control button set 107. The main spindle set 102 includes a main motor 1021, a main gear spindle 1022. The sub-cover spindle set 104 includes a sub-motor 1041, a motor gear 1042, a transfer gear 1043 engaged to the motor gear 1042, and a gear shaft 1044 engaged to the transfer gear 1043.

A keyboard 20 includes a keyboard body 201, an LED set 202, and a main control button 203. The main control button 203 is installed aside the keyboard body 201.

In use an actuation button 2032 of the main control button 203 is pressed firstly for covering the keyboard cover 10. The main cover plate 101 and the sub-cover plate 103 will be driven by the main spindle set 102 and the sub-cover spindle set 104 so as to change the orientation with respect to the keyboard 20. The sub-cover plate 103 is in contact with a table surface with a predetermined angle therebetween so as to support the main cover plate 101. The orientation of the main cover plate 101 is adjustable by pressing a fine adjustment button 2033 of the main cover plate 101.

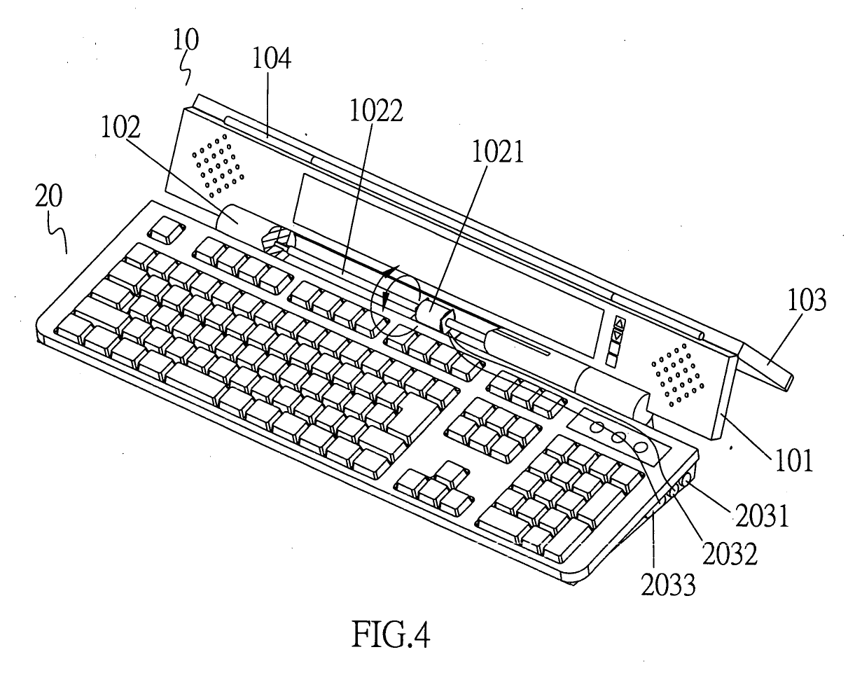

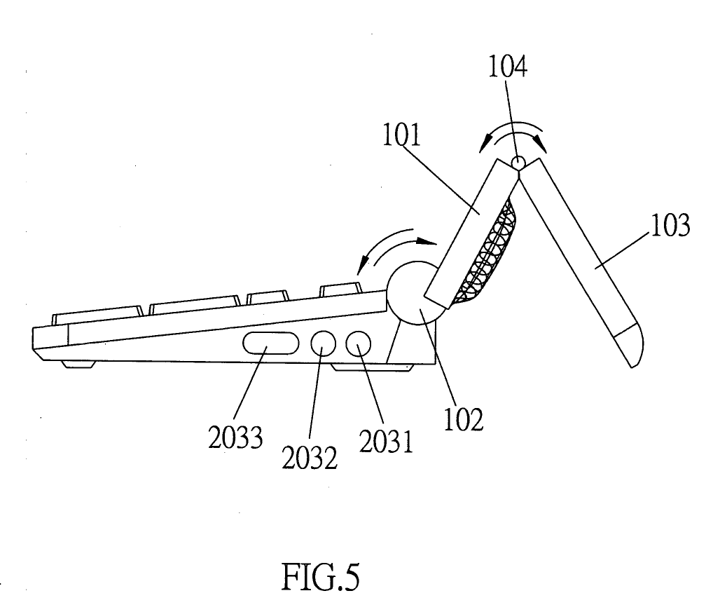

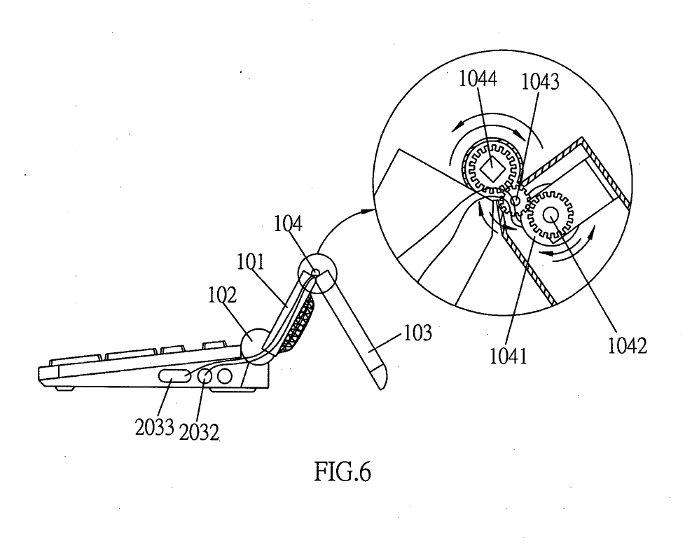

Referring to FIGS. 4, 5, and 6, after use, the actuation button 2032 of the main control button 203 is pressed again so as to close the keyboard cover 10. The motor 1021 will drive the main gear spindle 1022 so as to drive the main spindle set 102. Rotation of the main gear spindle 1022 will change the orientation of the main cover plate 101. The movement of the sub-cover spindle set 104 is driven by a sub-motor 1041 to drive the motor gear 1042 so as to further drive the gear shaft 1044 to rotate to change the elevation angle of the sub-cover plate 103.

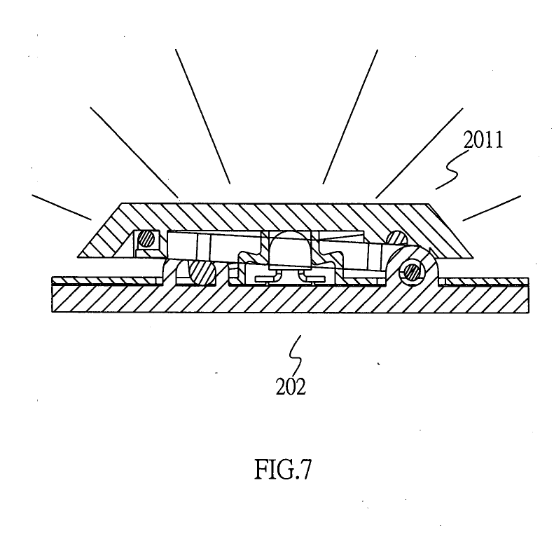

Referring to FIG. 7, a lower side of the keyboard body 201 is installed with the LED set 202. When the key 2011 is used, the LED will light up to illuminate the key 2011. When the mobile phone 30 has a call, the LED set 202 will light up the key 2011 with a random sequence which is controlled by an LED set ON/OFF button 2031 at the main control button 203.

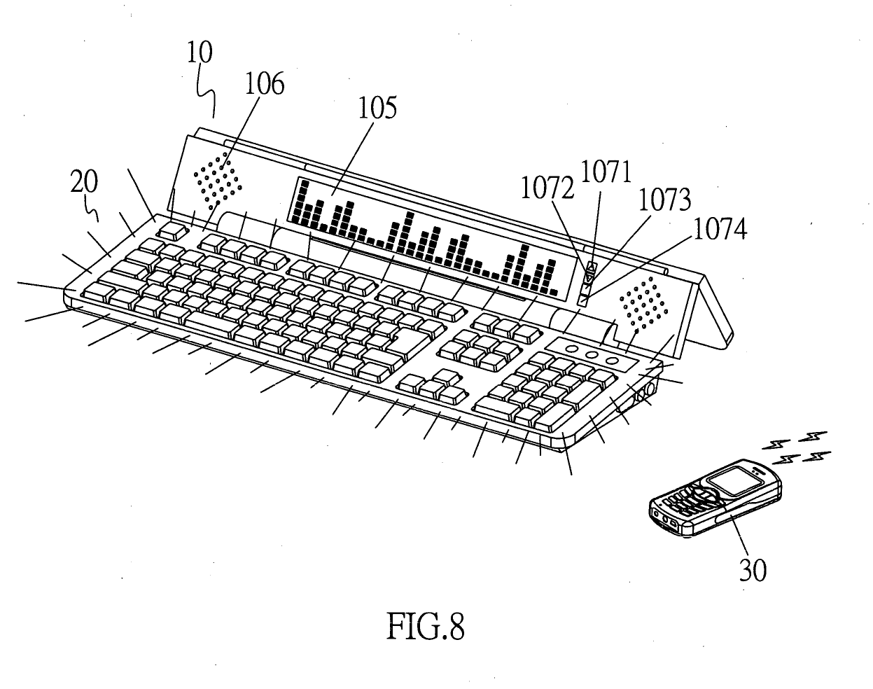

Referring to FIG. 8, a central portion of the a main cover plate 101 has the liquid crystal screen 105, sound control button 107, trumpet set 106 at two sides. When music is played, the images in the liquid crystal screen 105 will act with the rhythm of the music. The sound control button set 107 includes a volume enhancement button 1071, a volume reduction button 1072, a silence button 1073, and a HiFi button 1074.

The present invention is thus described, it will be obvious that the same may be varied in many ways. Such variations are not to be regarded as a departure from the spirit and scope of the present invention, and all such modifications as would be obvious to one skilled in the art are intended to be included within the scope of the following claims.

What is claimed is:

1. A keyboard with light and sound effects comprising:
an auto-uncover keyboard cover having a main cover plate, a main spindle set of the main cover plate, a sub-cover plate, a sub-cover spindle set, a liquid crystal screen, a trumpet set, and a sound control button set;
a keyboard including a keyboard body, an light emitting set, and a main control button;
wherein the cover and uncover operations of the keyboard cover are performed by the main spindle set and the sub-cover spindle set to drive the main cover plate and sub-cover plate and the main control button severs to control the liquid crystal screen, trumpet set, and sound control button set; and the light emitting set is installed below the keyboard body.

2. The keyboard with light and sound effects as claimed in claim 1, wherein the main spindle set includes a main motor, a main gear spindle; the sub-cover spindle set includes a sub-motor, a motor gear, a transfer gear engaged to the motor gear, and a gear shaft engaged to the transfer gear.

3. The keyboard with light and sound effects as claimed in claim 1, wherein the closing and opening of the main cover plate and sub cover plate are omni-directional.

4. The keyboard with light and sound effects as claimed in claim 1, wherein the sound control button set includes the functions of forwarding, reversing, pause, stopping, and silence.

5. The keyboard with light and sound effects as claimed in claim 1, wherein the light emitting set is an LED set which has a settable lighting sequence.

6. The keyboard with light and sound effects as claimed in claim 1, wherein a light sequence of the light emitting set is a random sequence determined by an incoming call of a mobile phone.

7. A keyboard with light and sound effects comprising:
an auto-uncover keyboard cover having a main cover plate, a main spindle set of the main cover plate, a sub-cover plate, a sub-cover spindle set, a liquid crystal screen, a trumpet set, and a sound control button set;
a keyboard including a keyboard body, an light emitting set, and a main control button;
wherein the cover and uncover operations of the keyboard cover are manual operated, and the main spindle set and the sub-cover spindle set serves to connect the main cover plate, sub-cover plate and the keyboard, and the main control button severs to control the liquid crystal screen, trumpet set, and sound control button set; and the light emitting set is installed below the keyboard body.
